(19) United States
(12) Patent Application Publication
(10) Pub. No.: US 2005/0125985 A1
(43) Pub. Date: Jun. 16, 2005

(54) Method for making a fiber reinforced composite rivet having an upset head

(76) Inventors: Thomas R. Adams, Huntington Beach, CA (US); Gary R. Wittman, Costa Mesa, CA (US)

Correspondence Address: MORLAND C FISCHER, 2030 MAIN ST, SUITE 1050, IRVINE, CA, 92614, US

(21) Appl. No.: 10/704,276

(22) Filed: Nov. 10, 2003

(51) Int. Cl. B23P 11/00; B21D 39/00

(52) U.S. Cl. 29/524.1; 29/505; 29/522.1; 29/525.06

(57) ABSTRACT

A method for making a composite rivet and upsetting the composite rivet after the rivet has been inserted through (e.g., composite) structural members to be held together. The rivet includes a core having continuous and unidirectionally extending fibers that are reinforced by a thermoplastic resin. The core is surrounded by a braided jacket having fibers arranged in a criss-cross weave. A forming die guide having a containment opening extending therethrough is positioned so that the upstanding end of the composite rivet is received within the containment opening. A heated forming die having a forming cavity is moved into the containment opening of the forming die guide so as to lie in axial alignment with the upstanding end of the rivet. A ram forces the heated forming die through the containment opening so that the upstanding end of the rivet is softened and upset within the forming cavity. The ability of the upstanding end of the rivet to spread out under the heat and pressure generated by the heated forming die is limited by the containment opening of the forming die guide.

### BACKGROUND OF THE INVENTION

1. Field of the Invention

This invention relates to a fiber reinforced composite rivet and to a method for upsetting one end thereof by means of compact, easy to use upsetting tools.

2. Background Art

Plastic and metal rivets are well known fasteners for connecting opposing structural members to one another. However, in certain applications, particularly those related to the aerospace industry, the weight associated with the conventional rivet can not be ignored. For example, when a very large number of rivets is used in an aircraft, the total weight of the aircraft is typically increased and the efficiency of operation is typically reduced.

To overcome the aforementioned weight problem and to provide a reliable, high strength means for connecting together opposing structural members, rivets made from a composite material have been proposed. In this case, a free upstanding end of the composite rivet must be upset during the assembly process in the field. Unfortunately, no compact, easy to use tool is known by which to enable a workman at a job site to upset the upstanding end of a composite rivet after the rivet has first been inserted through the structural members to be connected together.

### SUMMARY OF THE INVENTION

In general terms, a fiber reinforced composite rivet is disclosed that is capable of being upset so as to reliably connect together opposing (e.g., composite) structural members once the rivet has been inserted through the members. A rivet preform is initially positioned in an insert that is held by a mold base of a force generating press. The rivet preform is formed by continuous (e.g., carbon, quartz, glass, etc.) fibers that run unidirectionally (i.e., longitudinally) through the preform. The fibers are reinforced by a thermoplastic (e.g., PEEK or PPS) resin. The rivet preform is surrounded by an outer fiber braided jacket comprising continuous fibers that are arranged in a criss-cross weave. The fibers of the braided jacket are also reinforced by a thermoplastic resin.

A first end of the fiber preform projects upwardly into a female cavity of the insert within which the preform is positioned. The rivet preform and insert are heated in an oven, and the mold base is preheated within the press. The heated preform and insert are removed from the oven and located in the preheated mold base. The press is closed to apply pressure to the first end of the heated fiber preform, whereby the first end is softened and shaped by the female cavity of the insert so as to establish a composite rivet having a (e.g., flat) head. Once the preform has cooled down, the press is opened and the insert is removed from the mold base and cooled in water. The composite rivet is then pushed out of the insert and deflashed.

The composite rivet is now inserted through the opposing structural members to be connected together such that the newly formed head of the rivet lies at one side of the members and the upstanding core of the rivet projects to the other side of the members. A forming die guide is positioned so that the upstanding core of the composite rivet is received within a containment opening that is formed in the forming die guide. A heated forming die having a forming cavity at one end thereof is moved into the containment opening of the forming die guide so as to be axially aligned with the upstanding core. A ram is coupled to the heated forming die located within the containment opening of the forming die guide. The ram generates a pressure to cause the heated forming die to move towards and into contact with the upstanding core of the composite rivet, whereby the core is softened and shaped (i.e., upset) by the forming cavity of the forming die. The ability of the upset head to spread out during formation is restricted by the containment opening of the forming die guide which surrounds the upstanding core. A pointed tip within the forming cavity of the forming die leaves a depression in the upset head which directs the unidirectional fibers to the periphery of the upset head in order to improve the ability of the composite rivet to withstand tensile loads.

### BRIEF DESCRIPTION OF THE DRAWINGS

FIG. 1 shows a braided fiber preform having the preferred continuous, unidirectional fiber orientation prior to manufacture of the composite rivet of this invention;

FIG. 2 shows the fiber preform of FIG. 1 located within a heated insert so as to receive a force generated by a press during formation of the composite rivet;

FIG. 3 shows the composite rivet after it has been formed and removed from the insert of FIG. 2;

FIG. 4A is an exploded view illustrating the upsetting tools by which the upstanding core of the composite rivet of FIG. 3 is upset following insertion of the rivet through opposing structural members to be connected together;

FIG. 4B shows the upsetting tools of FIG. 4A coupled to one another and with the upstanding core of the composite rivet;

FIG. 4C shows the upsetting tools applying pressure to the upstanding core to provide the composite rivet with an upset head;

FIG. 4D shows the upset head of the composite rivet after the upsetting tools of FIG. 4C have been removed; and

FIG. 5 illustrates the fiber orientation of the composite rivet of FIG. 4D having an upset head.

### DETAILED DESCRIPTION

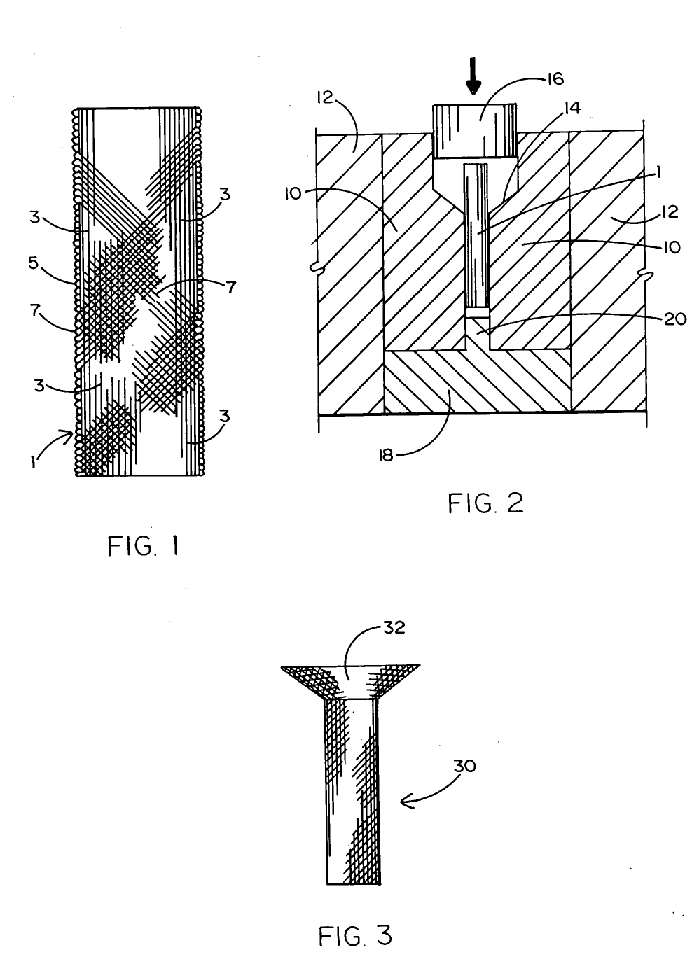

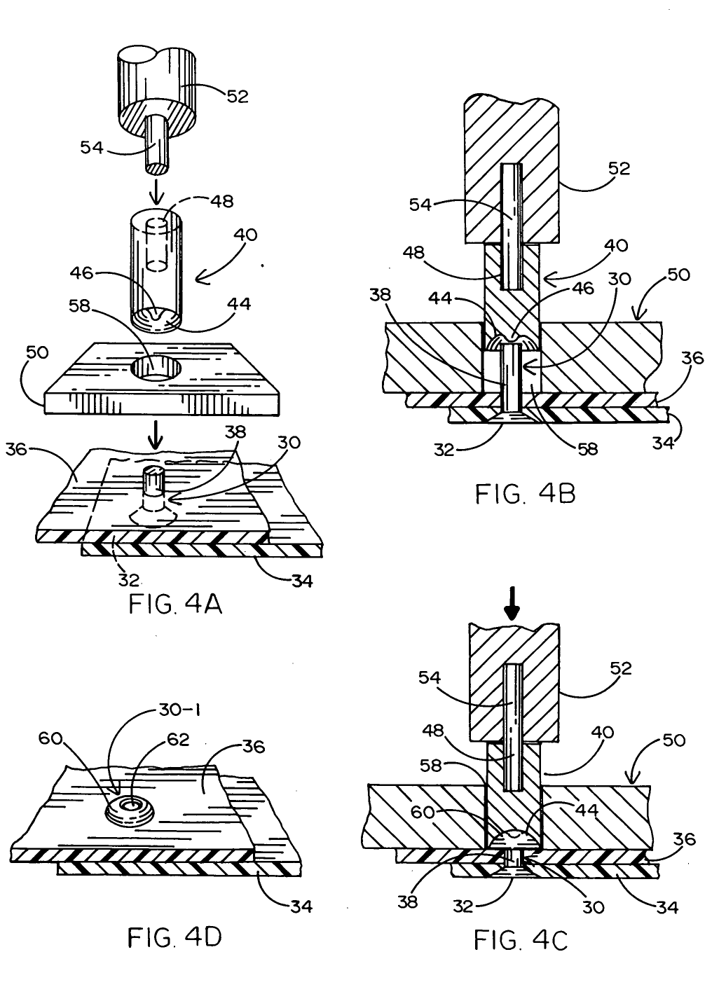

FIG. 1 of the drawings shows a rivet preform 1 which will be subject to heat, compression and solidification in order to form a fiber reinforced composite rivet 30 (of FIG. 3) that can be upset (as shown in FIG. 4) by means of compact and easy to use tools so that a pair of opposing (e.g., planar) composite structures can be reliably connected together. The rivet preform 1 (e.g., a pulltruded rod segment) includes a plurality of resin impregnated fibers 3. For maximum strength and reliability, the fibers running through the rivet preform 1 are both continuous and unidirectional (i.e., longitudinal) rather than chopped or random. By way of example, the fibers 3 of the rivet preform 1 are manufactured from carbon, quartz, glass, or the like. The fibers 3 are reinforced by a suitable thermoplastic resin such as, for example, that known as PEEK, PPS, or the like. A thermoplastic resin is preferable so as to enable one end of a composite rivet to be upset in a manner that will be explained in greater detail hereinafter when referring to FIG. 4.

The rivet preform 1 is surrounded by an outer braided jacket 5. The braided jacket 5 may be applied over and fused to the preform 1 by means of a conventional braiding machine. For purposes of efficiency, the application and fusing of the braided jacket 5 to the preform 1 may be completed during a single step. Like the rivet preform 1, the braided jacket 5 includes a plurality of continuous fibers 7 that are reinforced by a suitable thermoplastic resin. The braided jacket 5 surrounds the rivet preform 1 in a crisscross weave as shown in FIG. 1.

FIG. 2 of the drawings shows the braided composite rivet preform 1 of FIG. 1 being retained within an insert 10 of the kind that is typically installed in a mold base 12. The mold base 12 is preferably manufactured from aluminum to facilitate cooling during the manufacture of the headed rivet 30 shown in FIG. 3. In general, an elongated braided rod (not shown) is first produced (i.e., pulltruded), and the rod is then cut into smaller preform sections like that shown in FIG. 1 for receipt by the insert 10 of FIG. 2. A first end of the rivet preform 1 projects upwardly into a female cavity 14 at the top of insert 10. A male die 16 which cooperates with a conventional press (not shown) is supported above the female cavity 14 at the top of insert 10 so as to lie in spaced axial alignment with the first end of the rivet preform 1. A plug 18 is positioned within the mold base 12 so as to communicate with the bottom of insert 10. The plug 18 includes a pin 20 that projects upwardly within the insert 10 so as to lie in spaced axial alignment with the opposite end of the rivet preform 1.

The steps by which the rivet preform 1 of FIG. 1 is headed in order to produce the fiber reinforced composite rivet 30 of FIG. 3 are now described while continuing to refer to FIG. 2. The rivet preform 1 is pressed into the insert 10 so that the first end of preform 1 projects upwardly into female cavity 14, as shown. The insert 10, the rivet preform 1 and the male die 16 are all initially preheated to about 780 degree F. in a suitable oven. The mold base 12 and the bottom plug 18 are heated within the press to a temperature of approximately 500 degrees F. The heated preform 1, insert 10, and male die 16 are removed from the oven and placed in the preheated mold base 12 within the press.

The press is now closed to apply approximately 1,500 pounds of pressure for about three minutes to the first end of the heated rivet preform 1 by way of the heated male die 16. The corresponding pressure applied by male die 16 causes the composite material at the first end of preform 1 to soften and flow into the female cavity 14 of heated insert 10, such that a relatively wide and flat head (designated 32 in FIG. 3) is formed after cooling. The extension 20 of plug 18 applies holding pressure to the opposite end of the rivet preform 1 to prevent the preform from being extruded out of the bottom of the insert 10 during the formation of the head 32. While the head 32 is shown as being flat, other shapes are contemplated depending upon the shape of the female cavity 14 within which the composite material of preform 1 is forced.

Once the headed fiber preform has cooled down and solidified within the insert 10, the press is opened and the male die 16, mold base 12, insert 10, and preform 1 are all removed therefrom and turned upside down. Next, the combination of the male die 16, insert 10 and headed preform are separated from the mold base 12 and cooled in water, or the like, to a temperature preferably below 200 degrees F. The cooled combination is then placed in a well-known arbor press which pushes the male die 16 and the headed rivet preform 1 out of the insert 10. At this point, the male die 16 is simply pulled off and separated from the headed preform.

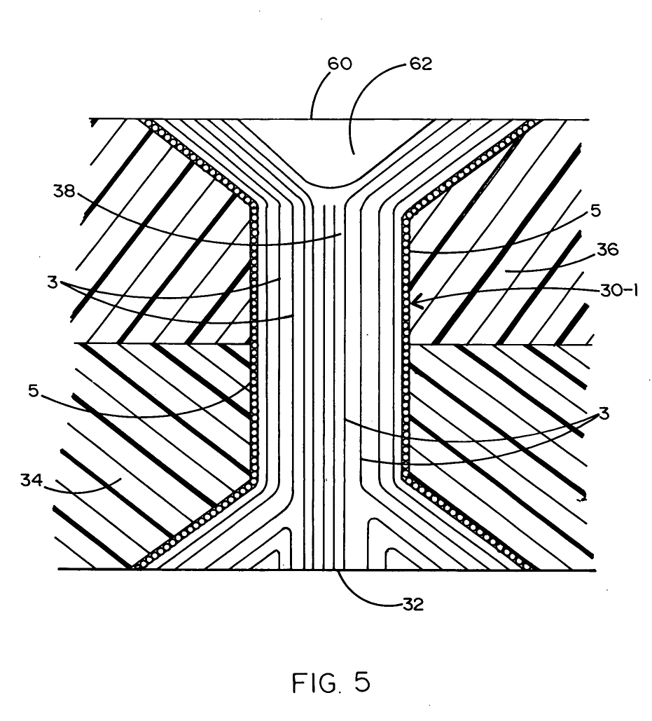

FIG. 3 of the drawings shows a fiber reinforced composite rivet 30 having a head 32 at one end thereof after the male die 16 has been separated from the preform 1 and the rivet 30 has been deflashed. The headed rivet 30 is characterized by the same continuous and unidirectional (i.e., longitudinally extending) fibers 3 and braided jacket 5 that were first described when referring to FIG. 1. In this same regard, FIG. 5 of the drawings more clearly illustrates the continuous and unidirectional fiber orientation as well as the braided jacket of the fiber reinforced composite rivet 30 after the end thereof that lies opposite the head 32 has been upset in a manner that will now be disclosed.

To this end, and turning to FIG. 4 of the drawings, the steps are described by which the opposite end of the fiber reinforced composite rivet 30 of FIG. 3 is upset. As indicated above, the composite rivet 30 has particular application for securing opposing composite structural members together. By way of example, FIG. 4A shows the composite rivet 30 inserted through a pair of axially aligned holes that are formed in a pair of composite plates 34 and 36 that are stacked one above the other. The head 32 at the first end of rivet 30 is positioned at one side of the plates 34 and 36, and the upstanding core 38 of rivet 30 extends through the plates 34 and 36 to the opposite side thereof.

The upstanding end of core 38 of composite rivet 30 is upset after being inserted through plates 34 and 36 by means of a forming die 40 and a forming die guide 50. The forming die 40 and the forming die guide 50 are preferably manufactured from heat treated tool steel. The leading end of forming die 40 includes a generally bowl-shaped forming cavity 44 and a central pointed tip 46 projecting outwardly past the forming cavity 44. The pointed tip 46 at the leading end of forming die 40 is important for directing the flow of continuous fibers at the upset end of the fiber reinforced composite rivet 30 in a manner to be described while referring to FIG. 5 so as to advantageously maximize the ability of rivet 30 to withstand tensile loads. The trailing end of forming die 40 lying opposite the forming cavity 44 and pointed tip 46 includes a recess 48 extending axially therewithin.

A ram 52 having a guide pin 54 projecting outwardly therefrom is spaced above the forming die 40 so that the guide pin 54 can be moved towards and into receipt by the recess 48 that is formed in the trailing end of forming die 40. In this way, the guide pin 54 can be moved to accurately position the forming die 40 relative to the upstanding end of the core 38 of the fiber reinforced composite rivet 30 that is to be upset.

FIG. 4B shows the guide pin 54 of ram 52 located within the recess 48 at the trailing end of forming die 40 so that the pointed tip 46 of forming die 40 is moved into contact with the upstanding end of core 38 of composite rivet 30. In this case, the forming die guide 50 is laid over the composite plates 34 and 36 to be connected together such that the upstanding end of core 38 of rivet 30 projects upwardly into a containment opening 58 that is formed in the forming die guide 50. In this same regard, the forming die 40 is positioned by the guide pin 54 of ram 52 so as to project downwardly into the containment opening 58 and thereby engage the upstanding end of core 38. With each of the forming die 40 and the upstanding end of core 38 of rivet 30 axially aligned with one another within the containment opening 58 and surrounded by the forming die guide 50, the ability of the core 38 to spread outside the containment opening 58 of forming die guide 50 will be blocked during the formation of an upset head (designated 60 in FIGS. 4C and 4D).

The details for forming the upset head 60 at the upstanding end of the core 38 of the fiber reinforced composite rivet 30 are now described while referring to FIG. 4C. Initially, the forming die 40 is placed into an oven and heated to about 1200 degrees F. The precise temperature to which the forming die 40 is heated will depend upon the composite material from which the rivet 30 is made. Once the forming die 40 has been heated, it is removed from the oven and coupled to the guide pin 54 of ram 52, as shown. With the upstanding end of the core 38 of composite rivet 30 extending through the composite plates 34 and 36 and projecting into the containment opening 58 in the forming die guide 50, the ram 52 pushes the heated forming die 40 downwardly through the containment opening 58 against the upstanding end of core 38. The ram 52 generates approximately 100-200 pounds of pressure for about 15 to 30 seconds to cause the upstanding end of core 38 to soften and flow into the forming cavity 44 (best shown in FIG. 4A) at the leading end of forming die 40, whereby to shape the upset head 60. In the alternative, the upstanding end of the core 38 can be softened by conventional ultrasonic techniques or other rapid heating techniques, such as induction heating.

It is to be understood that a backing force or pressure (not shown) must be applied to the lower composite plate 34 to oppose the pressure that is generated by the ram 52 and thereby prevent the core 38 of rivet 30 from being pushed downwardly and outwardly from the composite plates 34 and 36 that are to be connected together. Moreover, the ram 52 is preferably manufactured from a heat conductive metal (e.g., aluminum) so as to draw heat away from the forming die 40 during the formation of the upset head 60 so as to facilitate a rapid cooling.

After the upset head 60 of composite rivet 30 has cooled and solidified under pressure, the ram 52 is raised and the forming die 40 is lifted off the upset head. As indicated above, the forming die guide 50 surrounds both the upstanding end of core 38 and the forming die 40 to prevent the fibers of the composite rivet from spreading outside the containment opening 58 of guide 50 under the pressure that is generated by the ram 52 during the formation of the upset head 60. Accordingly, and as is best shown in FIG. 4D, a fiber reinforced composite rivet 30-1 is produced having a generally bowl shaped upset head 60 formed above the upper plate 36 and a flat head 32 that is flush with the lower plate 34, whereby to reliably hold the pair of composite plates 34 and 36 together. Because the upset rivet 30-1 as well as the plates 34 and 36 that are held together by rivet 30-1 are all manufactured from a composite material, each will have the same or substantially similar coefficient of thermal expansion. Thus, the upset composite rivet 30-1 will be able to completely fill the hole through composite plates 34 and 36 during changing thermal conditions so as to establish a more reliable connection therebetween.

The upset head 60 of the composite rivet 30-1 of FIG. 4D has an indentation 62 that is created by the pointed tip 46 which projects from the leading end of forming die 40 into the upstanding end of core 38 while the core is softened, shaped and cooled within the forming cavity 44. As previously described, the pointed tip 46 directs the flow of the unidirectional (i.e., longitudinally extending) fibers that run through the fiber reinforced composite rivet 30-1. More particularly, and referring now to FIG. 5 of the drawings, the fiber orientation of the composite rivet 30-1 is shown after the upset head 60 has been formed. The composite rivet 30-1 is shown in a double flush connection in FIG. 5 having the flat head 32 thereof positioned flush with the bottom composite plate 34 and the opposite upset head 60 positioned flush with the lower composite plate 36. However, the rivet 30-1 may also be connected to plates 34 and 36 in a single flush configuration as shown in FIG. 4D or in other rivet configurations such as, for example, a protruding head configuration (not shown).

The resin impregnated fibers 3 are shown in FIG. 5 running continuously and unidirectionally through the rivet 30-1. The indentation 62 that is created in the upset head 60 by the pointed tip 46 of forming tool 40 splits the flow and directs or flares the fibers 3 outwardly to the periphery of the upset head 60 to maximize the strength thereof. The strength of the composite rivet 30-1 is further increased by virtue of the braided jacket 5 which surrounds the core 38. That is, because of the ability of the braided jacket 5 to expand and contract, the orientation of the fibers 3 is more likely to follow the contour of the rivet 30-1 to maximize the tensile strength thereof. In addition, during expansion, the braided jacket 5 aids in directing the unidirectional fibers 3 to the periphery of the upset head 60 so as to help achieve optimal tensile characteristics.

1. A method for upsetting the upstanding end of a composite rivet so as to hold structural members together, said method comprising the steps of:
inserting the composite rivet through the structure members such that the upstanding end of the rivet projects outwardly therefrom;
locating a forming die guide having a containment opening extending therethrough such that the upstanding end of the composite rivet is received in said containment opening;
moving a forming die having a forming cavity towards the containment cavity of said forming die guide so as to communicate with the upstanding end of the composite rivet;
softening and shaping the upstanding end of the composite rivet within the forming cavity of said forming die; and
cooling the upstanding end of the composite rivet to form an upset head having a shape corresponding to the shape of said forming cavity.

2. The method for upsetting recited in claim 1, including the additional step of heating said forming die for softening and shaping the upstanding end of the composite rivet within the forming cavity of said forming die.

3. The method for upsetting recited in claim 1, including the additional step of heating said forming die in a furnace for softening and shaping the upstanding end of the composite rivet within the forming cavity of said forming die.

4. The method for upsetting recited in claim 1, including the additional step of applying pressure to said forming die when the upstanding end of the composite rivet is softened and shaped within the forming cavity of said forming die.

5. The method for upsetting recited in claim 4, including the additional steps of coupling a ram to said forming die; and moving said ram towards said forming die guide so as to force said forming die against the upstanding end of the composite rivet for applying said pressure to said forming die when the upstanding end of the composite rivet is softened and shaped within the forming cavity of said forming die.

6. The method for upsetting recited in claim 5, including the additional step of coupling said ram to said forming die by way of a guide pin projecting outwardly from said ram for receipt by said forming die.

7. The method for upsetting recited in claim 1, including the additional step of forming an indentation within the upset head of said composite rivet.

8. The method recited in claim 7, including the additional steps of forming said indentation within said upset head by means of a tip carried by said forming die and projecting from within said forming cavity thereof; and moving said forming die and said tip carried thereby into contact with the upstanding end of the composite rivet when said upstanding end is softened and shaped within said forming cavity.

9. The method of upsetting recited in claim 1, including the additional steps of forming the composite rivet to be upset from a core having a plurality of continuous fibers extending unidirectional and longitudinally therethrough; and reinforcing the fibers of said core with a thermoplastic resin.

10. The method recited in claim 9, including the additional step of surrounding the core of the composite rivet with a braided fiber jacket comprising fibers arranged in a criss-cross weave.

11. A method for making a composite rivet having an upset head for holding structural members together, said method comprising the steps of:
providing a rivet preform including a composite core having a plurality of unidirectional fibers running continuously therethrough and reinforced by a thermoplastic resin;
locating said rivet preform in an insert having a forming cavity such that a first end of said rivet preform projects into said forming cavity;
heating said insert and said rivet preform located therein;
applying pressure to the first end of said heated rivet preform for softening and shaping said first end within the forming cavity of said insert to form an enlarged rivet head;
cooling said rivet preform to produce said composite rivet with said enlarged rivet head having a shape corresponding to the shape of the forming cavity of said insert and then removing said composite rivet from said insert;
inserting said composite rivet through the structural members to be held together such that the enlarged rivet head of said composite rivet lies at one side of the structural members and the upstanding end of said composite rivet opposite the enlarged rivet head projects outwardly from the structural members to the opposite side thereof; and
forming said upset head by applying heat and pressure to the upstanding end of said composite rivet.

12. The method for making recited in claim 11, including the additional step of surrounding the composite core of said rivet preform with a braided jacket comprising fibers arranged in a criss-cross weave.

13. The method for making recited in claim 11, including the additional steps of locating a forming die within the forming cavity of said insert so as to lie in axial alignment with the first end of said heated rivet preform; and moving said forming die into contact with said first end for applying said pressure to said first end for softening and shaping said first end within the forming cavity of said insert.

14. The method for making recited in claim 13, including the additional step of heating said forming die before the step of moving said forming die into contact with the first end of said heated rivet preform for applying said pressure thereto.

15. The method for making recited in claim 14, including the additional steps of positioning said heated insert, said heated rivet preform located in said insert, and said heated forming die located within the forming cavity of said insert within a preheated mold base of a press; and closing said press against said heated forming die for moving said heated forming die into contact with the first end of said heated rivet preform for applying said pressure thereto.

16. The method for making recited in claim 11, wherein said step of forming said upset head includes the additional steps of:
locating an upsetting die guide having a containment opening extending therethrough so that the upstanding end of the composite rivet is received in said containment opening;
moving an upsetting die having an upsetting cavity into the containment opening of said upsetting die guide for applying said pressure to the upstanding end of the composite rivet;
softening and shaping the upstanding end of the composite rivet within the upsetting cavity of said upsetting die; and
cooling the upstanding end of the composite rivet to form said upset head having a shape corresponding to the shape of said upsetting cavity.

17. The method for making recited in claim 16, wherein said step of forming said upset head by applying heat to the upstanding end of said composite rivet includes heating said upsetting die for softening and shaping said upstanding end within the upsetting cavity of said upsetting die.

18. The method for making recited in claim 17, including the additional steps of coupling a ram to said heated upsetting die; and moving said ram toward said upsetting die guide for forcing said heated upsetting die against the upstanding end of the composite rivet and thereby applying said pressure to said upstanding end when said upstanding end is softened and shaped within the upsetting cavity of said heated upsetting die.

19. The method for making recited in claim 16, including the additional step of forming an indentation within the upset head of the composite rivet.

20. The method recited in claim 19, including the additional step of forming said indentation within said upset head when said upsetting die is moved into the containment opening of said upsetting die guide by means of a tip carried by said upsetting die and projecting from within said upsetting cavity thereof.
